(19) United States
(12) Patent Application Publication
(10) Pub. No.: US 2012/0325985 A1
(43) Pub. Date: Dec. 27, 2012

(54) ROTARY STAND FOR TV SCREEN OR MONITOR

(76) Inventors: Christopher Slowinski, Great Neck, NY (US); Krzysztof Kazana, Kraków (PL); Kamil Sienkiel, Ostrowiec Swietokrzyski (PL)

(21) Appl. No.: 13/432,854

(22) Filed: Mar. 28, 2012

(30) Foreign Application Priority Data
Mar. 29, 2011 (PL) P.394387
Oct. 20, 2011 (PL) P.396710

(51) Int. Cl. F16M 13/02; F16M 13/00

(52) U.S. Cl. 248/121

(57) ABSTRACT

A rotary stand for TV screen or monitor, which require an adjustable angular position relative to its vertical axis, secured in a holder in a bearing column, mounted rotationally in a fixed mount, fitted with a controlled electric drive of the bearing column bi-directional rotation and a potentiometer for electric adjustment of the bearing column angular position is described together with a support stand that is mountable to a lateral wall. A potentiometer directly coupled with the bearing surface, and a friction clutch, as a component of a kinematic drive chain, transfers torque from the electrical drive to the bearing column. The stand has a programmable control system enabling the limit angular positions of the screen secured in the holder on the bearing column to be automatically set and programmed.

### CROSS REFERENCE TO RELATED APPLICATIONS

The present application claims priority of Polish Patent Application Nos. P.396710, filed Oct. 20, 2011, and P.394387, filed Mar. 29, 2011, the entire contents of which are hereby incorporated in full by reference.

### FIELD OF THE INVENTION

Television and display stands and mounts that can be secured to a piece of furniture or a wall.

### BACKGROUND OF THE INVENTION

Rotating a TV screen or monitor, with an angle of rotation testing system are known. Solutions fitted with this function use various external sensors for adjusting the set angular position, for instance magnetic or induction sensors. However these solutions are not particularly flexible and do not ensure a sufficient accuracy of the angle of rotation adjustment for the viewer. At the same time potentiometric systems for measuring the angle of rotation of a moving member are known.

A potentiometer for measurement the angle of rotation of a shaft compared with a fixed member is known from U.S. Pat. No. 5,113,172. The potentiometer has two resistance paths situated concentrically on a fixed disk. On the second disk, seated in parallel to the fixed disc and rotating together with a shaft, two collector paths are mounted as concentric circular paths. Two brushes of the collector paths contact slideably the resistant paths. The measurement signal is obtained from contacts situated on the fixed disc and connected to the resistance paths.

A device for rotating a TV screen with the adjustment of the angle of rotation using a potentiometer driven by an electric motor and a couple of permanently meshed gear wheels as a control and measurement component is known from US/2006/0284034. A solution like this provides freedom to adjust the screen angle of rotation, however due to the use of intermediary gear wheels and plays in the toothed gear it has little precision. For wide screens, even a small difference in the angle of rotation causes a substantial shift of the screen edge. The device is fitted with a control system enabling the rotation to be stopped once the set angle of rotation of the screen relative to its vertical axis has been reached, as read from the potentiometer signal. The set angle is stored in the memory system.

Also mounts for seating a monitor or TV screen at a distance from a wall or in a piece of furniture are known. In these solutions the support is a plate, on which a fastening member is seated, fitted with a plate or two arms secured to the rear wall of the screen.

### SUMMARY OF THE INVENTION

An object of the invention is to introduce a screen stand allowing precise control, with accuracy to a half degree, of the rotary movement of the bearing column actuated by an electric drive.

An object of the invention is to provide a rotary stand for a TV screen or monitor such that the angular position of the TV screen is adjustable relative to its vertical axis, and the TV is secured in a holder on a vertical carrying column, mounted rotationally in a stationary mount, fitted with a controlled electric drive of bi-directional rotary movement of the carrying column.

A characteristic feature of the invention is an automatic control system using a potentiometer, directly, concentrically coupled with the bearing column, to adjust the angular position of the screen, which is secured with a holder on the bearing column and a friction clutch, being a component of a kinematic chain transferring the torque from the electric drive to the bearing column. The power unit transferring the torque consists of the electric drive turning the bearing column with the friction clutch and the main gear, whose driven wheel is concentrically, permanently seated on the bearing column and constitutes its drive. The bearing column is rotationally seated, advantageously in a position perpendicular to the mount plane, on a fixed mount.

A significant feature of the invention is also a programmable microprocessor control system enabling the limit angular positions of the screen secured in the holder on the bearing column to be automatically set and programmed. The complete potentiometer comprises a ring, directly coupled with the rotary bearing column, on which a slide is fixed, and a disk with concentrically situated ring-shaped resistance paths. The slide rotates together with the bearing column, at the same time sliding on the resistance path on the disk. The angular position of the bearing column is read by the potentiometer by measuring the voltage level on the resistance path. The design features of the potentiometer enable it to controllably turn up to 320 degrees. The measurement is interpreted by an internal microprocessor system, which then controls, in accordance with the software algorithm, the operation of the positioning power unit. This sort of design allows the device position angle to be set with the accuracy up to ½-1 degree, eliminating errors in angle measurement in the device mechanical system, which is unattainable in the existing solutions.

The control system software enables the limit angular positions of the screen secured in the holder on the bearing column to be automatically set and stored. The signal that shuts the power unit off is the recorded slide of the friction clutch, therefore it is essential that the maximum torque transferred by the friction clutch be correctly pre-set. This setting depends most of all on the foreseen weight of the screen.

Stopping of the drive resulting from a friction clutch slide is a signal to the control system, actuating the reverse movement of the bearing column by the set angle value. Next, the control system may store this position in its non-volatile memory.

A solution like this has many operating advantages. Among others the self-programming of limit angular positions of the screen resulting from the close distance between the screen and the wall is possible. In addition, this solution protects the screen and the stand against damage when other accidental items happen to be in the way of the turning screen.

The control system also enables selected screen angular positions to be pre-programmed. The control system may be programmed according to several known methods. The most convenient programming method for the proposed device is remote wireless programming or in some potential applications remote programming via a wired connection. When an operator has convenient access to the stand, the programming panel may be directly incorporated in the stand body.

Another object of the invention is to provide a support for a TV screen or monitor secured in the holder on the vertical carrying column, mounted rotationally, moved by the bidirectional rotary movement electric drive or manually.

A versatile mount is provided to enable an electrically or manually driven screen to be mounted on any plate or directly on a furniture wall.

A support according to the invention consists of a vertical stand and a horizontal fastening member. Accordingly, the screen support is a spatial angular support comprising at least two walls situated vertical to the base plane, connected at first ends to the stand holder and at the other ends—to a lateral wall setting the fastening plane situated perpendicularly to the base plane. The support walls have a spatial framework construction with ribs. The lateral wall may have also a spatial framework construction with ribs.

The angular support cross-section has an “L” shape in the fastening position with the horizontal leg longer and the vertical leg shorter. The lateral wall has means for fastening the support to the fastening plane. In the holder a rotary stand is mounted with a controlled electric drive of bi-directional rotary movement of the carrying column, seated rotationally against the stationary support, perpendicularly to the base plane.

An electronic module is placed between the support walls. A recorder and player socket is situated in the electronic module cover.

The advantage of the solution according to this aspect of the invention is the stability of the support and safe holding of a TV set by it. At the same time the simple design of the support facilitates its mounting and restraining in the base. The angular support enables the TV set to be secured to plates of various sizes and directly to the furniture. A compact design and wires hidden inside the support provide its functional and aesthetic values.

Other features and advantages of the present invention will become apparent from the following description of the invention, which refers to the accompanying drawings.

### BRIEF DESCRIPTION OF THE DRAWINGS

The solution according to the invention is presented in the embodiments in the drawings, where the individual figures present:

FIG. 1 illustrates rotary stand in an exploded view;

FIG. 2 illustrates electric drive and the friction clutch assembly in an exploded view;

FIG. 3 illustrates potentiometer components put on the bearing column in a perspective view;

FIG. 4 illustrates examples of potential angular positions of the device;

FIG. 5 illustrates a diagram showing the method of self-programming of the limit positions of the device;

FIG. 6 illustrates a diagram showing a reaction of the device to a barrier;

FIG. 7 illustrates a diagram showing the kinematic drive chain and control;

FIG. 8 illustrates the support in an exploded view;

FIG. 9 illustrates the support in an exploded view, with the electronic module shown;

FIG. 10 illustrates a TV set seated on the support, in a perspective view from the front;

FIG. 11 illustrates a TV set seated on the support, in a perspective view from the back;

FIG. 12 illustrates a stand with an extension piece;

FIG. 13 illustrates a receiving mechanism for mounting the stand;

FIG. 14 illustrates a rubber clamp;

FIG. 15 illustrates a furniture mounting a support;

FIG. 16 illustrates a perspective view of the furniture mounting support for glass;

FIG. 17 illustrates a support for mounting to a wall;

FIG. 18 illustrates a control panel with volume buttons and IR receiver eye;

FIG. 19 illustrates the stand with lighting ring;

FIG. 20 illustrates the TV stand with the rotation device.

With reference to the Drawings, the features thereof are described below.

### DETAILED DESCRIPTION OF EMBODIMENTS OF THE INVENTION

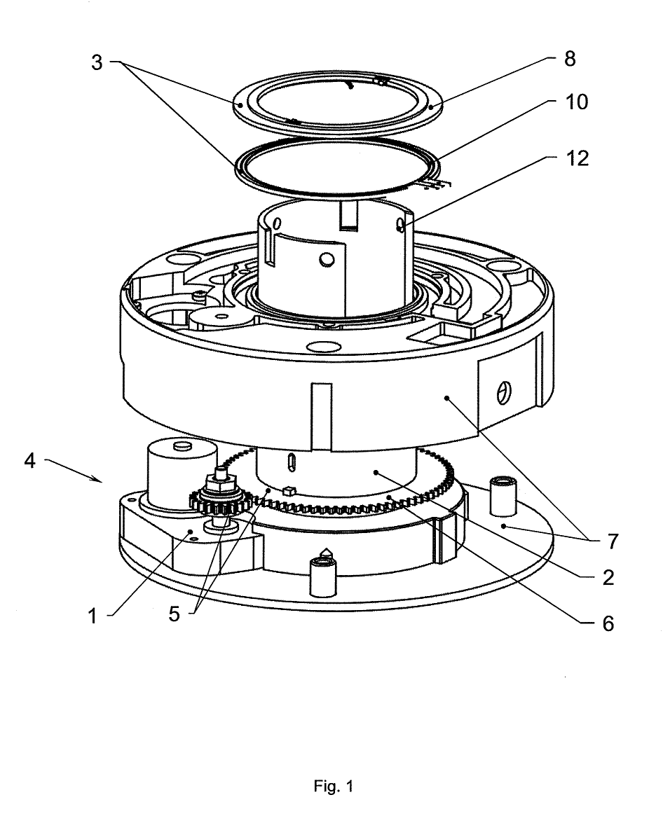

According to an embodiment, the rotary stand of a TV or monitor screen according to the invention, shown in FIG. 1 with a controlled electric drive 1 of bi-directional rotation of a bearing column 2 is fitted with a potentiometer 3 for electric adjustment of the angular position of the bearing column 2. The controlled rotation of the stand bearing column 2 is forced with the power unit 4, comprising:

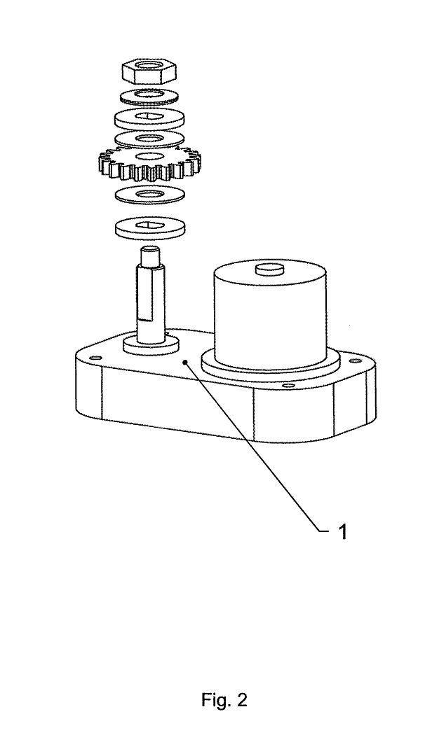

an electric drive 1, shown in FIG. 2,

a friction clutch, not shown in the drawing, which is integrated in one casing with the electric drive 1,

a main toothed gear 5, whose driven wheel is concentrically permanently seated on the bearing column and constitutes its drive.

The bearing column 2 is rotationally seated in a fixed mount 7, in a position perpendicular to the mount plane 7.

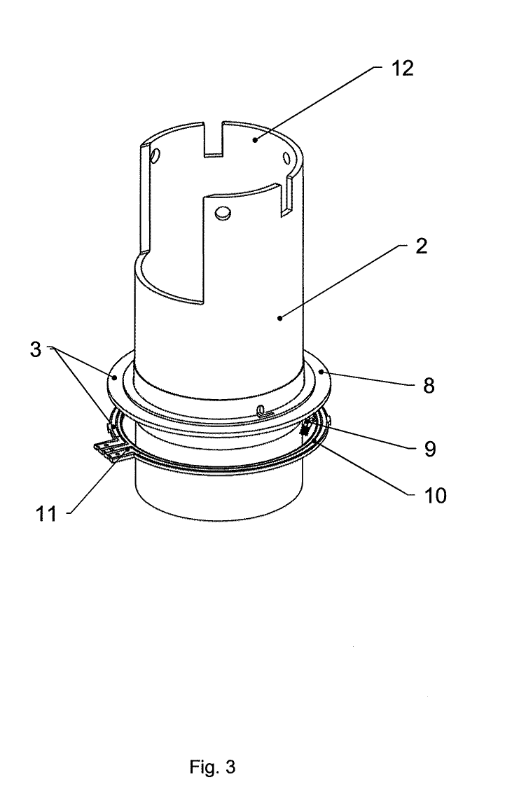

The main component of the bearing column 2 position angle adjustment system is a potentiometer 3, seen in FIG. 3, which is directly coupled to the bearing column 2.

The complete potentiometer comprises a ring 8, on which a slide 9 is fixed, stationary mounted on the bearing column 2, and a disk 10 with concentrically situated ring-shaped resistance paths 11. The slide 9 rotates together with the bearing column 2, at the same time sliding on the resistance paths 11 on the disk 10. The angular position of the bearing column 2 is read by the potentiometer 3 by measuring the voltage level between the end contacts of the resistance paths 11. The design features of the potentiometer 3 enable a controlled turn up to 320 degrees.

A change in voltage is read and interpreted by an embedded microprocessor system, not shown in the drawings, which next controls the operation of the positioning power unit 4. Design like this allows the position angle of the device to be read with the accuracy up to ½ degree, and to be set with the accuracy up to 1 degree, which is unattainable in the existing applied solutions.

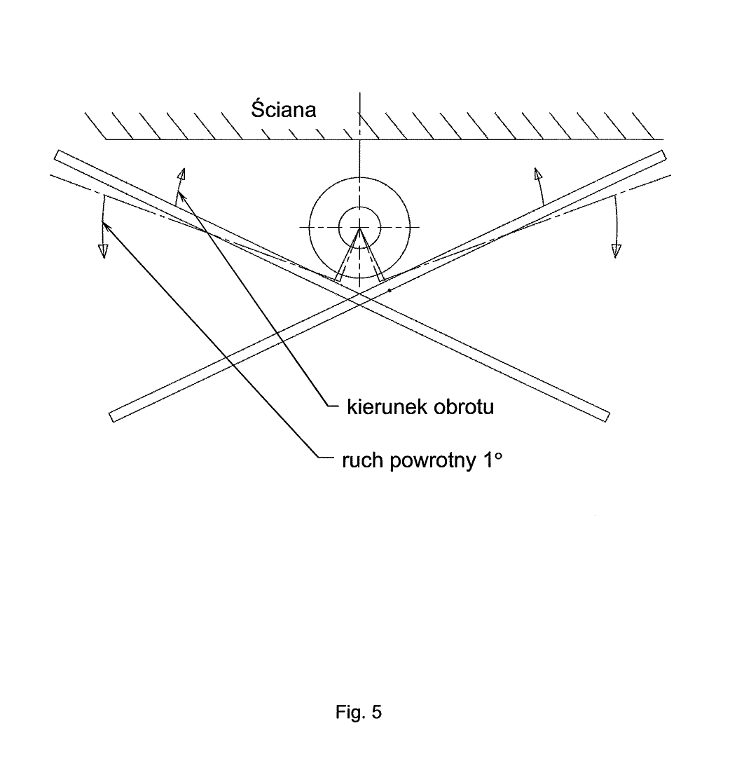

The control system software enables the limit angular positions of the screen secured in the holder 12 on the bearing column 2 to be automatically set and stored, which is diagrammatically shown in FIG. 5. A signal to switch the electric drive 1 off is the recorded slide of the friction clutch, resulting from the forced physical stop of the bearing column 2 rotation. A situation like this takes place when the screen rotation is blocked, e.g. by a wall or another barrier. While encountering a barrier, the device reads the value of potentiometer 3 voltage, which is invariable in time. At the same time the control system has the information about the continuous operation of the electric drive 1 and a slide of the friction clutch.

Stopping of the electric drive 1 by the programme, resulting from a reaction to the friction clutch slide, is a signal to the control system, actuating the reverse movement of the bearing column 2 by the set value of angle, advantageously around 1 degree. Next, the control system may store this position in its non-volatile memory. The reverse movement after stopping the rotation by a barrier is advantageous on account of safety of operations. It protects the system against repeatable contact of the screen edges with e.g. a wall, at each maximum angular displacement.

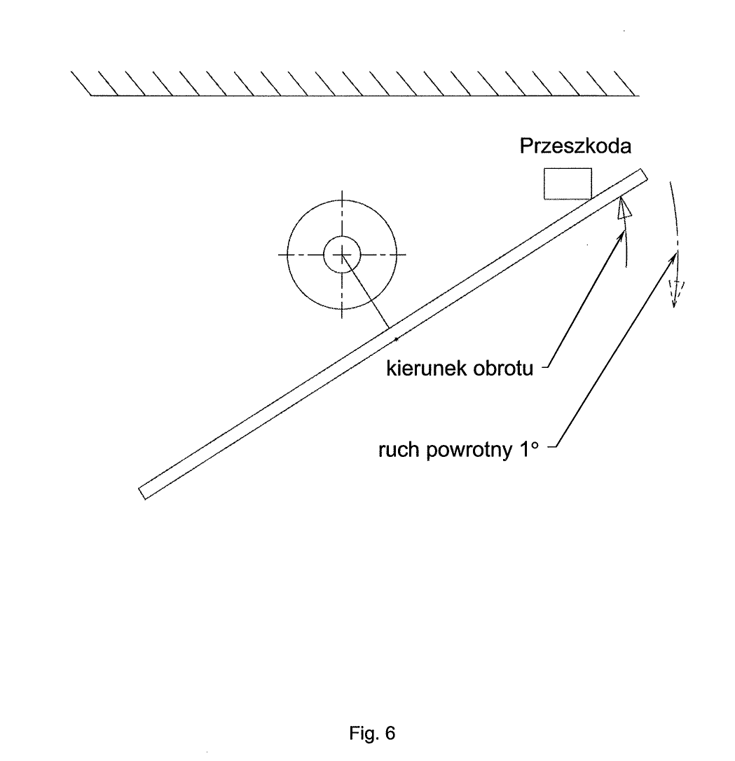

A solution like this has many operating advantages. Among others the self-programming of the limit angular positions of the screen resulting from the close distance between the screen and the wall is possible. In addition, this solution protects the screen and the rotary stand against damage when other accidental items happen to be in the way of the rotating screen. The described situation is presented in FIG. 6.

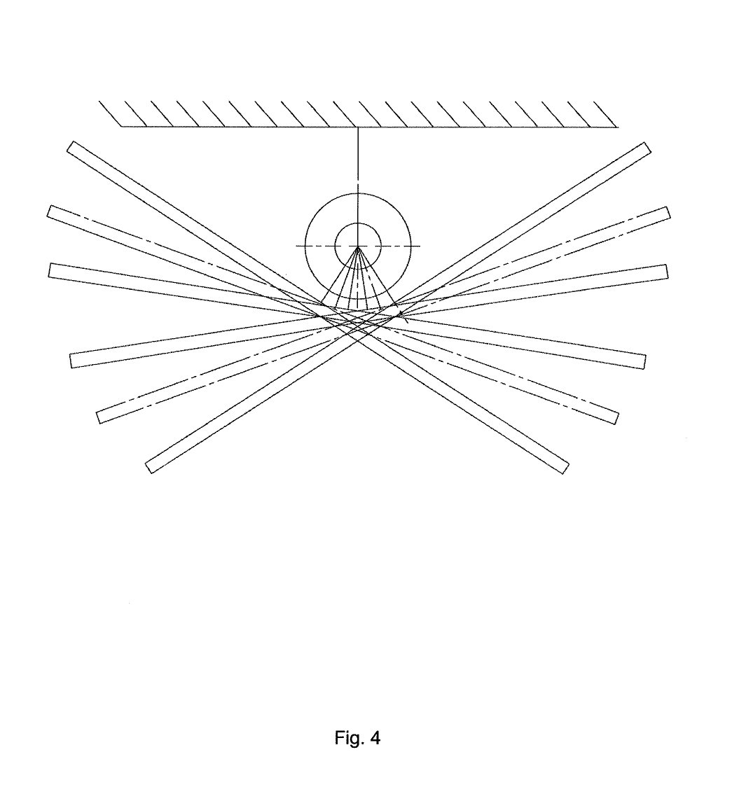

Also the control system enables selected screen angular positions to be pre-programmed. Example angular positions of the device are shown in FIG. 4.

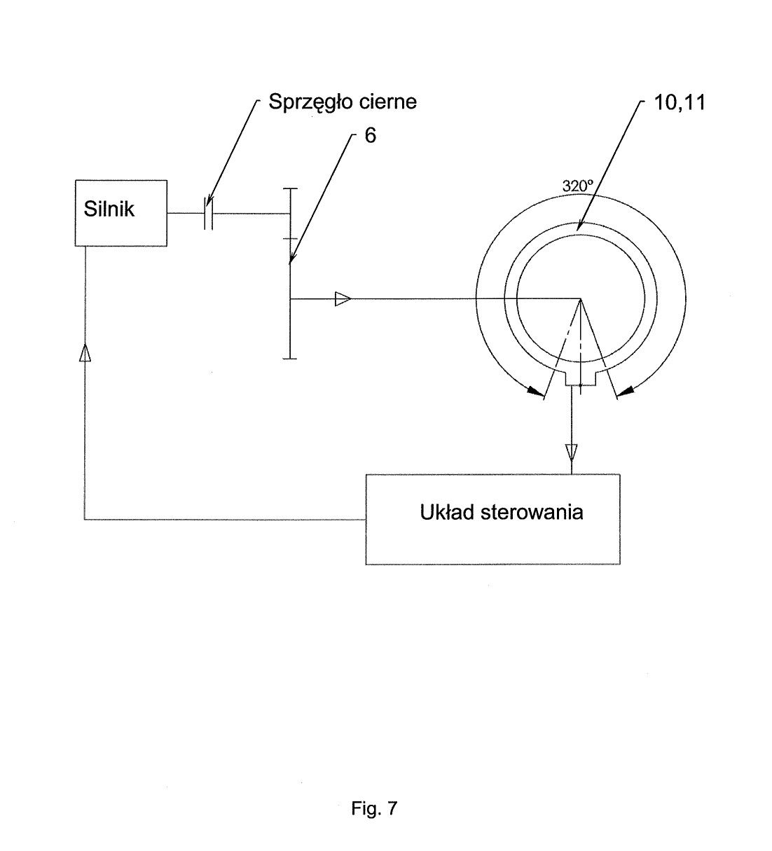

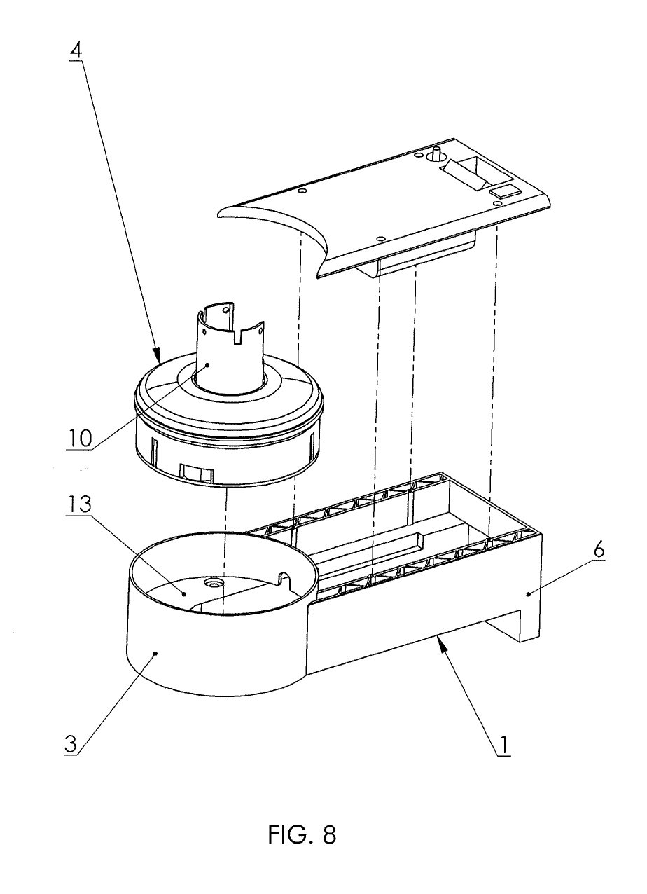

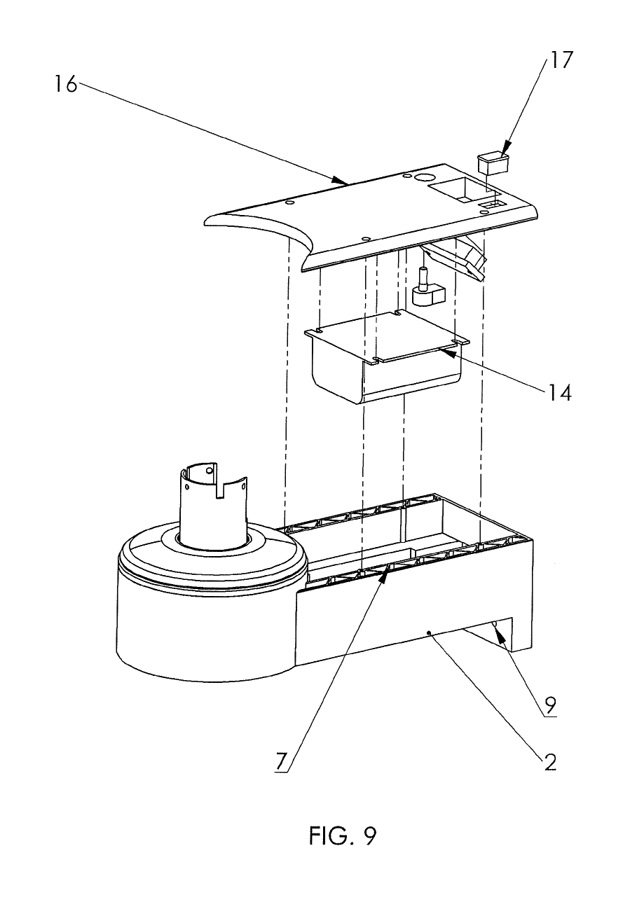

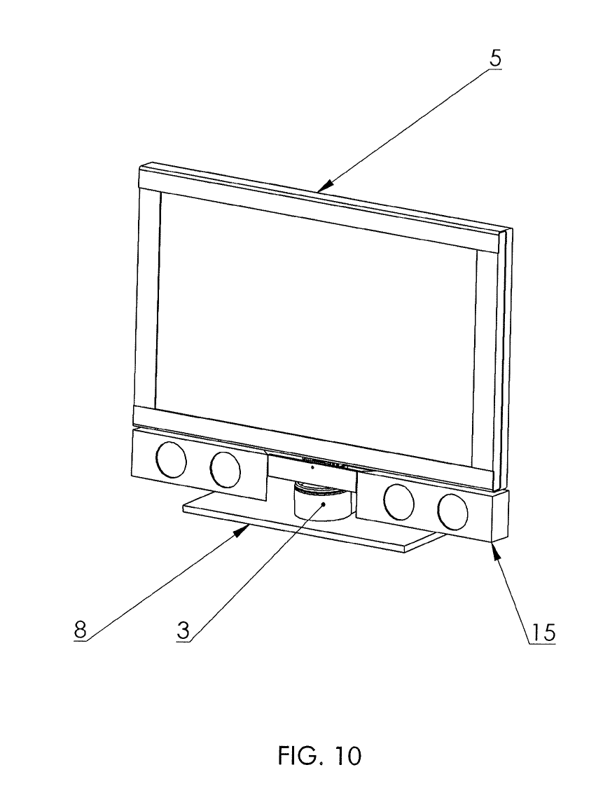

The control system, presented diagrammatically in FIG. 7 is programmable by a remote wireless device.

The support of a TV screen according to the invention is also provided. The support has the form of a spatial angular support 81 comprising two walls 82 situated vertically perpendicularly to the base P. The walls 82 are connected at first ends to the holder 83 of the stand 84 of the screen 85 and at the other ends—to the lateral wall 86. Therefore the angular support cross-section has an “L” shape in the fastening position with the horizontal leg longer and the vertical leg shorter. The support 81 walls 82 have a spatial framework construction and are fitted with bracing ribs 87. Also the lateral wall 86 may be a framework member with analogous ribs.

The lateral wall 86 is a member fastening the support, situated adjacent to the fastening plane M vertical to the base P. The base P plane is basically determined by a horizontal mounting plate 88 or a horizontal top wall of the piece of furniture, while the fastening plane M—by the vertical edge of the said plate 88 or vertical rear wall of the piece of furniture. The lateral wall 86 has holes 89 for screws or fastening bolts.

A rotary stand 4 with a controlled electric drive of the carrying column 90 bidirectional rotary movement is seated in the holder 83. The carrying column 90 is seated rotationally against the fixed support 81, in a position perpendicular to the base plane P. The screen 85 is mounted on the carrying column 90 with carrying arms 91 and a beam 92. The holder 83 may be alternatively equipped with a non-motorized stand 84 and then the column 90 with the secured screen 85 is rotated manually. The stand 84 is seated on an internal shelf 93 of the holder 83.

The electronic module 94 is placed between the support 81 walls 82. Basically, this module is an amplifier connected to additional loudspeakers 95 of the TV set. The main switch 97 and a socket for a recorder and player 98 are situated in the electronic module 94 cover 96. At the same time this socket may be a docking and power supply station for the said piece of equipment 98. Power supply and transmission wires of all equipment of the support are lead between the support 81 walls 82 and inside the tubular carrying column 90.

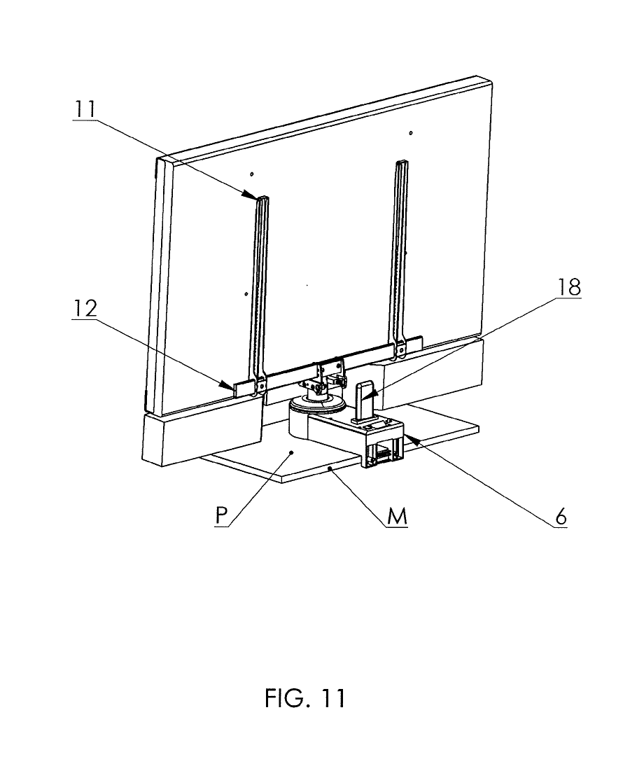

FIG. 12 illustrates an extension piece for mounting the mounting support for the TV. Customers may wish to mount the TV support on furniture pieces of various depths or may wish to position the TV screen more forward or more rearwardly with respect to the piece of furniture to which the mounting support is attached. Accordingly, extension piece 101 may be provided and the lateral walls 86 could be integrally formed or be secured to extension piece 101. Accordingly, spatial angular support 81 and holder 83 can move retractably back and forth inside extension piece 101.

In the alternative, spatial angular support 81 may be attached to the top of extension piece 101 and may be retractably moved back and forth on top of extension piece 101 as required by the viewer for the particular furniture piece depth, the desired maximum rotation angle of the television, and other such considerations.

Inside extension piece 101 may be a track or a couple of set parallel tracks on which spatial angular support 81 moves. In addition, both the top and bottom inside portions of extension piece 101 may have one or more such tracks on which spatial angular support 81 moves or the lateral inside walls of extension piece 101 may have the tracks. In the alternative, extension piece 101 may have one or more protruding guide lips positioned as above-described with respect to the tracks, and the spatial angular support 81 may have the track or tracks for mating with the grooves of extension piece 101.

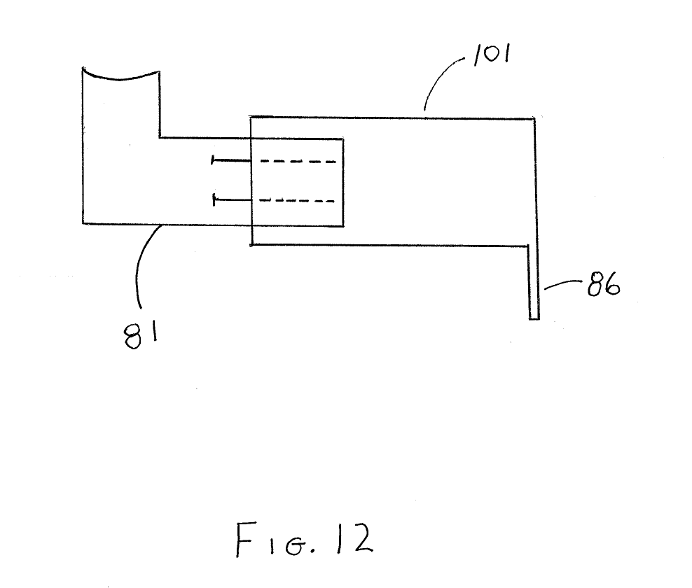

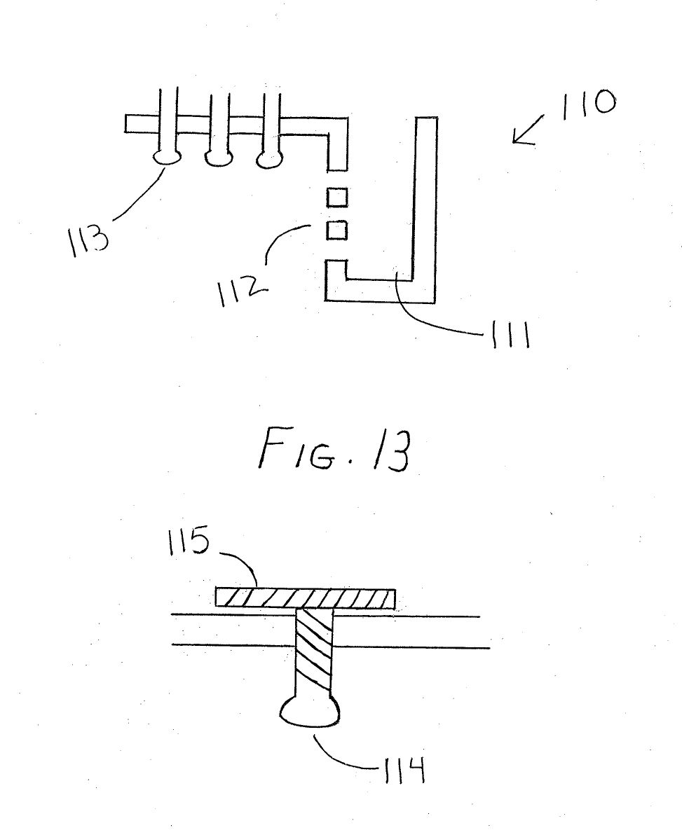

FIG. 13 illustrates bottom sleeve 110 configured to receive lateral wall 86 of the mounting support. It may be the case that the back of the furniture piece on which the stand is situated may not be suitable for drilling holes for screws or the user may wish not to drill holes there or this surface may be a glass surface or other subservice which makes drilling screw holes difficult, and thus the user may wish to drill holes on the bottom of the furniture piece. Also, the side of the furniture piece or table may be too thin for drilling the screw holes and thus the customer may wish to attach the support to the bottom of the furniture. Accordingly, bottom sleeve 110 receives lateral wall 86 inside recess 111 and lateral wall 86 may be secured to bottom sleeve via screws 112. Then, the entire bottom sleeve 110 may be attached to the bottom of the furniture piece using screws 113.

In the alternative, bottom sleeve 110 may be attached to the bottom of the furniture piece using clamps 114 instead of screws 113 so as to obviate the need to drill on the bottom of the furniture piece. Clamp 114 may have hard rubber piece for attaching to the bottom of the furniture piece. Such an application may be particularly advantageous when the furniture piece is glass, porcelain or other type of materials where drilling is impossible, difficult or risks damage to the furniture piece.

FIG. 14 illustrates rubber pad 120 mounted on the bottom of spatial angular support 81. Rubber pad 120 can be chosen so as to provide a high coefficient of friction and thus to prevent sliding of the support on the furniture piece which is mounted. Such sliding can damage the TV, upset the degree of rotation of the TV and the viewing angle, and can damage the surface of the furniture piece. In addition, rubber pad 120 can prevent damage by screws positioned at lateral wall 86 by shifting in the screw holes in which they are mounted thus preventing undue torque of the screws.

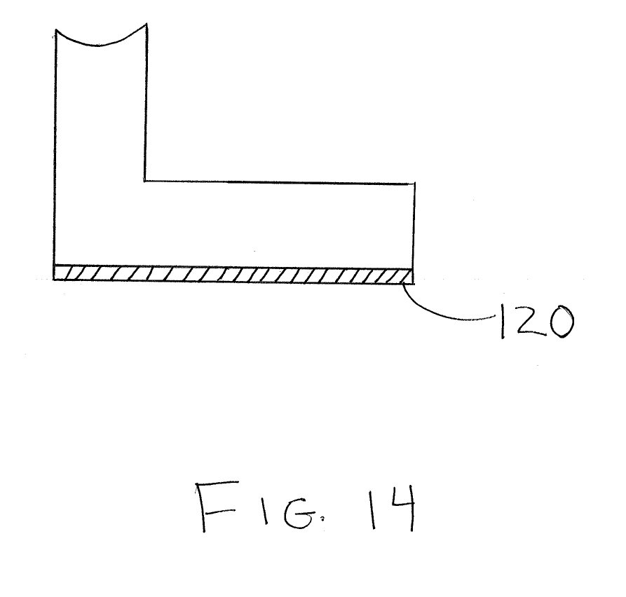

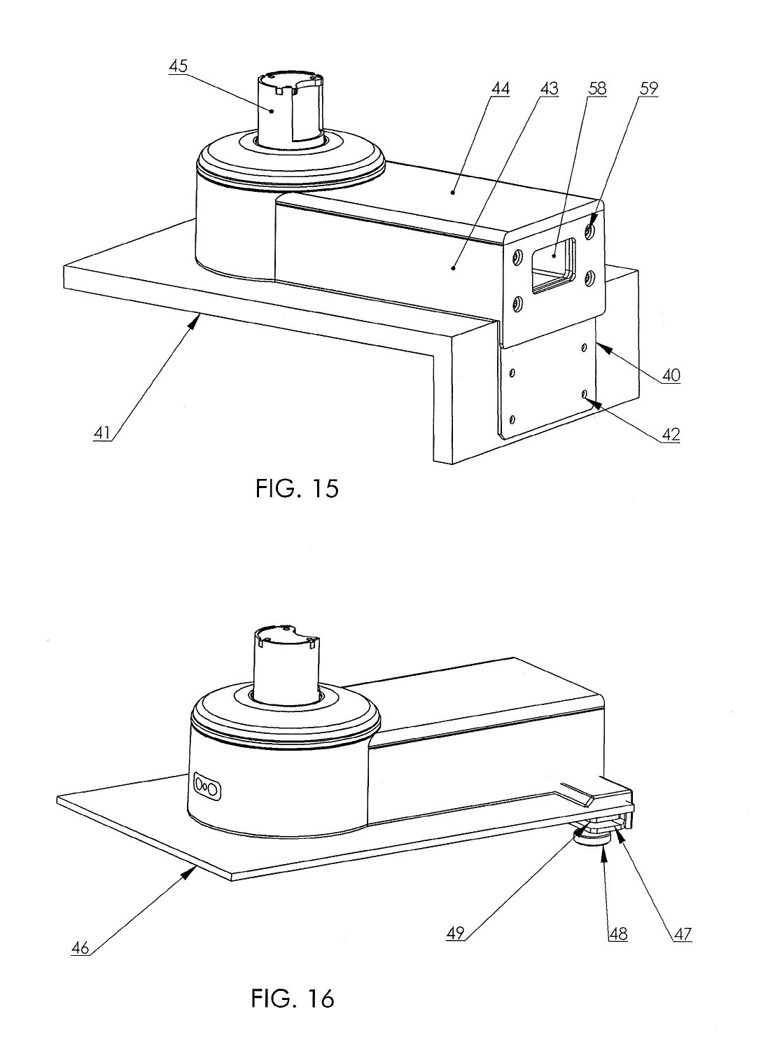

Also shown is a stand for a large TV with a stand of special stiffness steel construction. FIGS. 15-20 show several embodiments of these features.

FIG. 15 illustrates standard furniture mounting to a furniture panel 41 top and back with sufficient strength. Furniture mounting metal plate 40 with existing mounting holes 42 is directly fixed to carrying steel construction 58 with mounting screws 59. Carrying steel construction 58 is encased with decorating cover 43 and closed from top side with top decorating cover 44. Rotation device 45 is directly assembled to carrying steel construction 58 with supplied screws.

FIG. 16 illustrates a glass mounting method. Glass mounting metal plate 47 with already mounted two handwheel 48 and pressure plate 49 is provided. All these parts can be provided as an integrated element able to hold glass 46 with sufficient strength.

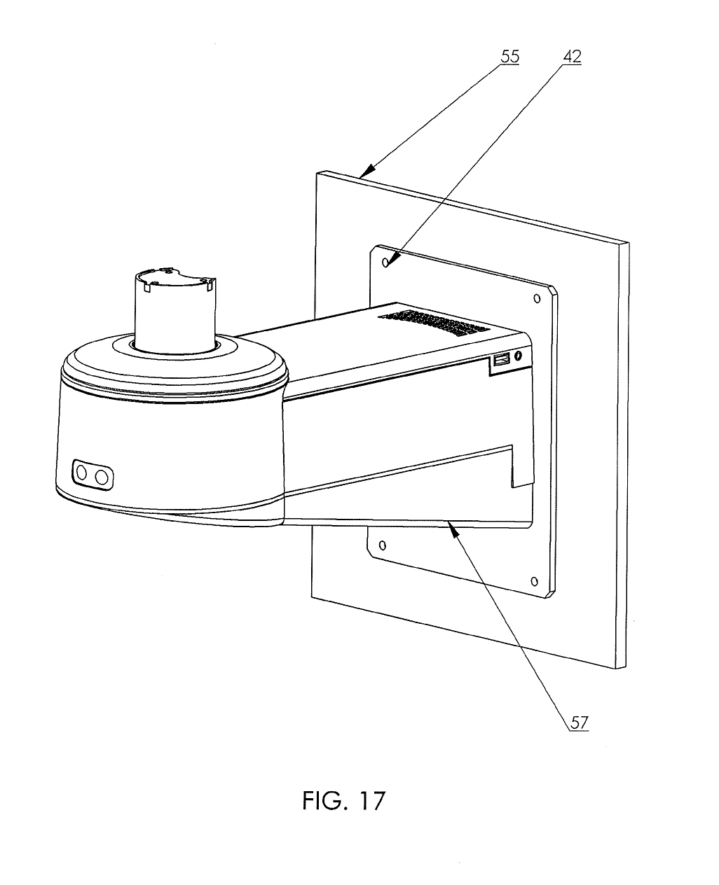

FIG. 17 shows a wall mounting solution. Carrying steel construction 58 is directly mounted to carrying wall construction 58 and fixed through mounting holes 42 to wall 55 with mounting screws 59.

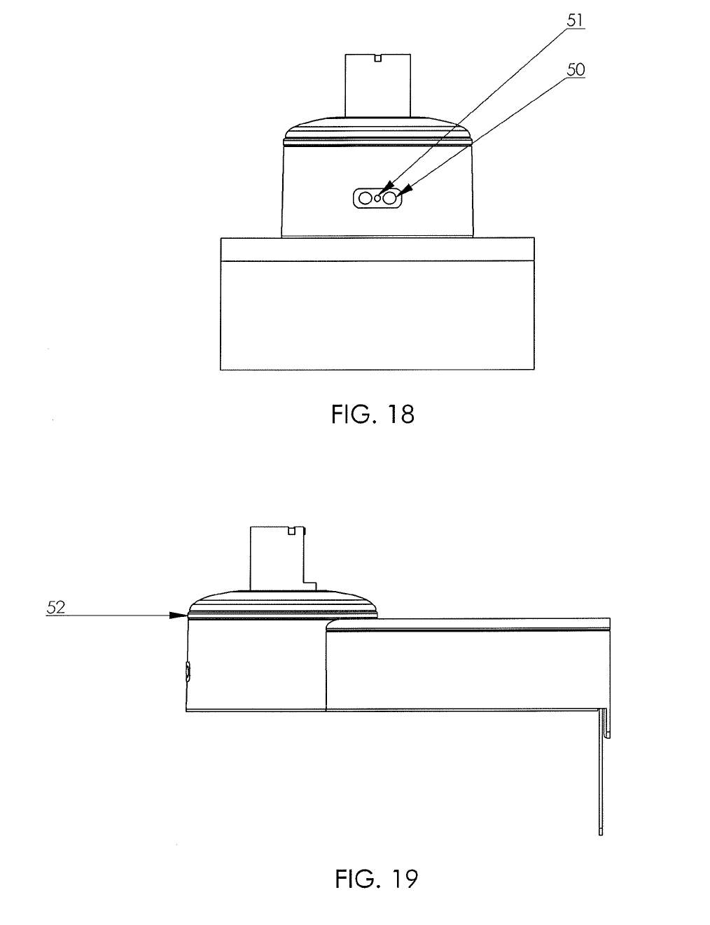

FIG. 18 shows a control panel with volume buttons 50 and IR receiver eye 51. Panel may be integrated with internal electronic devices and control their functions.

FIG. 19 illustrates lightning ring 52, which functionally is an optical wave guide for user lightning communication states. Light can be permanent or intermittent regarding to rotation mechanical running function.

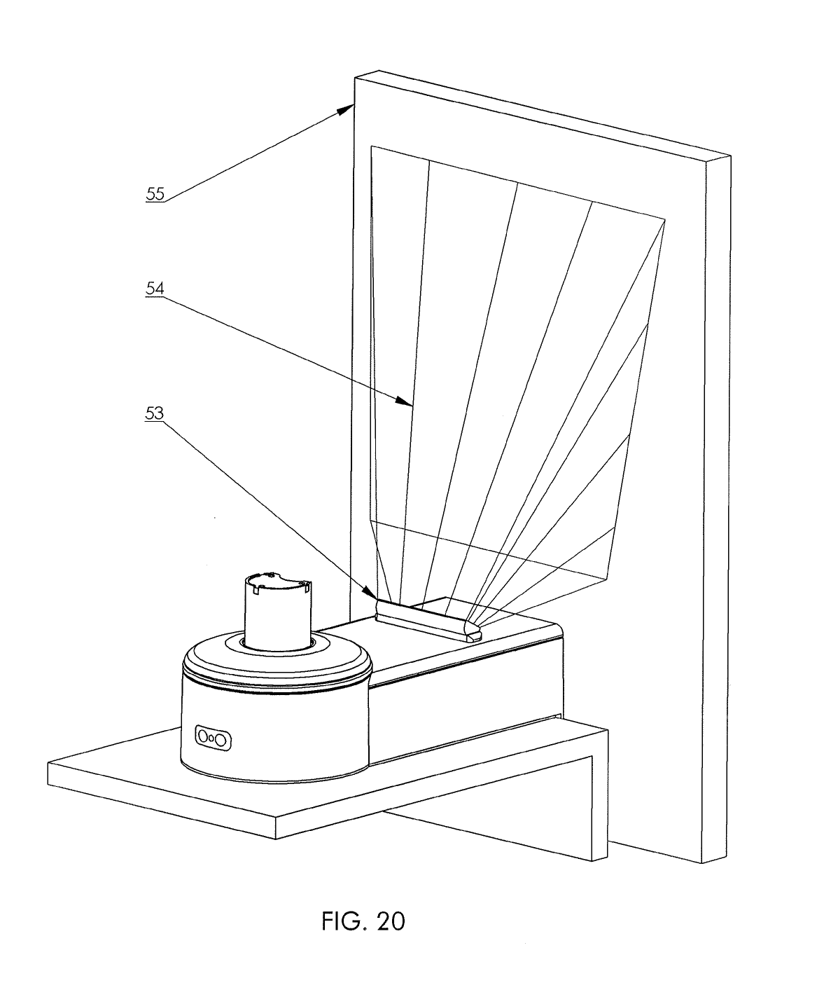

FIG. 20 illustrates a complete TV stand a with rotation device that may be equipped with background tilting light 53 to illuminate back TV area and wall at the back of TV. Drawing shows lightning sheaf 54 principle of operation.

In accordance with an embodiment that has been reduced to practice the TV screen or monitor support comprises: a base including a fastening member and a horizontally extending base body having a flat bottom surface configured to rest on a flat furniture surface, said base body having a supporting end and a fastening end; a turning mechanism located at the supporting end of the base body, said turning mechanism including a holder for holding said TV screen or monitor; said fastening member extending substantially perpendicularly from said fastening end of said base body; and said fastening member being configured to enable said base body to be immovably and securely secured to a furniture item.

The base body preferably comprises two spaced walls which extend substantially perpendicularly to said flat bottom of said base body, wherein said walls have a spatial framework constructed with ribs. The base body is free of any means of the securement thereof to said furniture item. Also, the base body and said fastening member together comprise an angular support that has an “L” cross-sectional shape, with a horizontal leg that is longer and a vertical leg that is comparatively shorter.

The turning mechanism may include an electrical drive of bi-directional rotary movement, seated rotationally on the base body, perpendicularly to the flat bottom of the base body.

An electronic module is housed within the base body and including a cover for the base body, with a socket for a recorder and player supported by the cover. The fastening member may include a clamping mechanism with a clamp for clamping the support to a table or furniture top by clamping of said furniture top between said bottom surface of the base and the clamp. The fastening member may include openings for receiving screws or bolts that extend horizontally, or the fastening member includes openings for receiving screws or bolts that extend vertically. A high co-efficient material e.g. rubber, attached to the bottom surface of the base body, to prevent movement of the base body on a support surface of the furniture item on which it has been located. Also, the fastening member may include a horizontally extending slide that is configured to slide within said base body, in order to enable adjusting the distance between said supporting end and said fastening member.

The turning mechanism includes a motor and bi-directional rotation circuit therefor, said bi-directional rotation circuit including a potentiometer for enabling electrical adjustment of a maximum angular position, a bearing surface coupled with said potentiometer, a friction clutch comprising a component of a kinematic drive chain transferring torque from an electrical drive to said bearing surface.

The invention constitutes a rotary stand for TV screen or monitor, which require an adjustable angular position relative to its vertical axis, comprising: a holder in a bearing column, mounted rotationally in a fixed mount, fitted with a controlled electric drive of the bearing column bi-directional rotation; a potentiometer for electric adjustment of the bearing column angular position, said potentiometer being directly coupled with the bearing surface; and a friction clutch, as a component of a kinematic drive chain, transferring torque from the electric drive to the bearing column. A component of the potentiometer is coupled with the bearing surface and comprises a ring with a slide attached thereto. The range of rotation of the ring with the slide attached is at least 320 degrees. A disk for the potentiometer with resistance paths is fixed stationarily in a mount, concentrically with the ring of the potentiometer. A kinematic driving chain, constituting a power unit comprises an electric drive, a friction clutch and a main gear. A driven wheel of a main drive being fixed stationary and concentrically on the bearing column. A programmable control system enabling limiting angular positions of the screen is secured in a holder on the bearing column to be automatically set and programmed. The slide of the friction clutch is a signal for shutting of the electric drive. A stop of the drive resulting from a slide of the friction clutch is a signal for actuating the reverse movement of the bearing column by a set value of angle. The control system software contains a function of storing selected angular positions of the bearing column. The control system is programmed with a wireless remote control device. The control system is programmed with a wired remote control device.

Although the present invention has been described in relation to particular embodiments thereof, many other variations, combinations of features and modifications and other uses will become apparent to those skilled in the art. It is preferred, therefore, that the present invention be limited not by the specific disclosure herein, but only by the appended claims.

What is claimed is:

1. A TV screen or monitor support, comprising:
a base including a fastening member and a horizontally extending base body having a flat bottom surface configured to rest on a flat furniture surface, said base body having a supporting end and a fastening end;
a turning mechanism located at the supporting end of the base body, said turning mechanism including a holder for holding said TV screen or monitor;
said fastening member extending substantially perpendicularly from said fastening end of said base body; and
said fastening member being configured to enable said base body to be immovably and securely secured to a furniture item.

2. The support of claim 1, wherein said base body comprises two spaced walls which extend substantially perpendicularly to said flat bottom of said base body.

3. The support of claim 2, wherein said walls have a spatial framework constructed with ribs.

4. The support of claim 1, wherein said base body is free of any means of the securement thereof to said furniture item.

5. The support of claim 1, wherein said base body and said fastening member together comprise an angular support that has an “L” cross-sectional shape, with a horizontal leg that is longer and a vertical leg that is comparatively shorter.

6. The support of claim 1, wherein the turning mechanism includes an electrical drive of bi-directional rotary movement, seated rotationally on the base body, perpendicularly to the flat bottom of the base body.

7. The support of claim 6, further including an electronic module housed within the base body.

8. The support of claim 1, further including a cover for the base body.

9. The support of claim 8, further including a socket for a recorder and player supported by the cover.

10. The support of claim 1, wherein the fastening member includes a clamping mechanism with a clamp for clamping the support to a table or furniture top by clamping of said furniture top between said bottom surface of the base and the clamp.

11. The support of claim 1, wherein said fastening member includes openings for receiving screws or bolts that extend horizontally.

12. The support of claim 1, wherein said fastening member includes openings for receiving screws or bolts that extend vertically.

13. The support of claim 1, including a high co-efficient material attached to the bottom surface of the base body, to prevent movement of the base body on a support surface of the furniture item on which it has been located.

14. The support of claim 13, wherein said material comprises rubber.

15. The support of claim 1, wherein said fastening member includes a horizontally extending slide that is configured to slide within said base body, in order to enable adjusting the distance between said supporting end and said fastening member.

16. The support of claim 1, wherein said turning mechanism includes a motor and bi-directional rotation circuit therefor, said bi-directional rotation circuit including a potentiometer for enabling electrical adjustment of a maximum angular position, a bearing surface coupled with said potentiometer, a friction clutch comprising a component of a kinematic drive chain transferring torque from an electrical drive to said bearing surface.

17. A rotary stand for TV screen or monitor, which require an adjustable angular position relative to its vertical axis, comprising:
a holder in a bearing column, mounted rotationally in a fixed mount, fitted with a controlled electric drive of the bearing column bi-directional rotation;
a potentiometer for electric adjustment of the bearing column angular position, said potentiometer being directly coupled with the bearing surface; and
a friction clutch, as a component of a kinematic drive chain, transferring torque from the electric drive to the bearing column.

18. The rotary TV stand as claimed in claim 17, wherein a component of the potentiometer is coupled with the bearing surface and comprises a ring with a slide attached thereto.

19. The rotary TV stand as claimed in claim 18, wherein the range of rotation of the ring with the slide attached is at least 320 degrees.

20. The rotary TV stand as claimed in claim 17, including a disk for the potentiometer with resistance paths fixed stationarily in a mount, concentrically with the ring of the potentiometer.

21. The rotary TV stand as claimed in claim 17, wherein a kinematic driving chain, constituting a power unit comprises an electric drive, a friction clutch and a main gear.

22. The rotary TV stand as claimed in claim 17, including a driven wheel of a main drive being fixed stationary and concentrically on the bearing column.

23. The rotary TV stand as claimed in claim 17, including a programmable control system enabling limiting angular positions of the screen secured in a holder on the bearing column to be automatically set and programmed.

24. The rotary TV stand as claimed in claim 18, wherein the slide of the friction clutch is a signal for shutting of the electric drive.

25. The rotary TV stand as claimed in claim 18, wherein a stop of the drive resulting from a slide of the friction clutch is a signal for actuating the reverse movement of the bearing column by a set value of angle.

26. The rotary TV stand as claimed in claim 18, wherein the control system software contains a function of storing selected angular positions of the bearing column.

27. The rotary TV stand as claimed in claim 18, wherein the control system is programmed with a wireless remote control device.

28. The rotary TV stand as claimed in claim 18, wherein the control system is programmed with a wire remote control device.
